(19) United States
(12) Patent Application Publication
(10) Pub. No.: US 2004/0139072 A1
(43) Pub. Date: Jul. 15, 2004

(54) System and method for locating similar records in a database

(76) Inventors: Andrei Z. Broder, Bronx, NY (US); Mark S. Manasse, San Francisco, CA (US)

Correspondence Address: MORGAN, LEWIS & BOCKIUS, LLP., 3300 HILLVIEW AVENUE, PALO ALTO, CA, 94304, US

(21) Appl. No.: 10/341,738

(22) Filed: Jan. 13, 2003

(51) Int. Cl. G06F 7/00

(52) U.S. Cl. 707/4

(57) ABSTRACT

The invention provides a system and method for locating records in a database storing objects similar to a specified object. A set of object expansion rules and a set of canonicalization rules are applied to the specified object to generate a sequence of tokens. A set of features are then generated for the sequence of tokens. Generating a set of features includes: generating a set of characters from the sequence of tokens; assigning an identification element to each character in the set of characters to create a set of identification elements; creating a set of permuted identification elements; selecting a predetermined number of permuted identification elements from the set of permuted identification elements; partitioning the selected, permuted identification elements into a plurality of groups; and producing a feature value from each of these groups. Finally, a set of objects from the database with a predefined number of feature values in common with those of the specified object are located. Each object in the set of objects is similar to the specified object. Further, an object may be, for example, a name or an address.

The present invention relates generally to system and method for searching for records in a database, more particularly, the present invention relates to locating records in a database that are similar to a specified record.

### BACKGROUND OF THE INVENTION

Various agencies, such as the Department of Motor Vehicles or the Social Security Administration, need to search for probable matches of individual names from large lists. Applications that require searching include fraud detection, customer record retrieval, database merging, duplicate record detection/removal, and data mining.

Searching for names in a database poses several problems. For example, names contain variations due to phonetics (Paine vs. Pane or Payne), missing words (John Quincy Adams vs. John Adams), and noise words (ACME Incorporated may be listed as ACME). Names also contain variations due to the use of nicknames (Bill vs. William), prefixes (Van Helsing vs. vanHelsing), sequence variations (Paul Simon vs. Simon Paul), or keyboard errors. Still other name variations include abbreviations such as JFK instead of John F. Kennedy. And frequently, there are words or names that end with “ie” or “y” (Bill, Willy, Billie, Billy instead of William or Willie).

Existing systems for locating similar names (e.g. Soundex) group together names that are pronounced similarly but spelled differently. Soundex is an indexing system that translates names into a four digit code consisting of one letter and three numbers. Soundex keys have the property that words pronounced similarly produce the same Soundex Key, and can thus be used to search databases for similar sounding names. However, such systems are limited because they do not consider the other reasons for variations listed in the preceding paragraph.

Other systems, such as IntelligentSearch.com, use rules-based algorithms to locate matching names. These systems include rules for addressing discrepancies caused by phonetic variations, nicknames, noise words, handling common prefixes, diminutive recognition, etc. These rules-based systems are, however, limited with respect to detecting forms of variations caused by letters and sounds migrating from the end of a first name to the beginning of the last name.

Consequently, there is a need in the art for a system that rapidly matches names against a database of names while accounting for more variations regardless of the cause.

### SUMMARY OF THE INVENTION

In summary, the present invention provides a system and method for locating records in a database storing objects similar to a specified object. A set of object expansion rules and a set of canonicalization rules are applied to the specified object to generate a sequence of tokens. A set of features are then generated for the sequence of tokens. Generating a set of features includes: generating a set of characters from the sequence of tokens; assigning an identification element to each character in the set of characters to create a set of identification elements; creating a set of permuted identification elements; selecting a predetermined number of permuted identification elements from the set of permuted identification elements; and partitioning the selected, permuted identification elements into a plurality of groups; and producing a feature value from each of these groups. Finally, a set of objects from the database with a predefined number of feature values in common with those of the specified object are located. Each object in the set of objects is similar to the specified object.

In the preferred embodiment, the database includes a list of features and a set of record identifications corresponding to each feature in the list of features. The record identification uniquely identifies each record (i.e., object) stored in the database. An application module is used to interface between the acquisition module, a record database, and a record locator module. The acquisition module is used to add additional information identifying records and features to the database. And the record locator module is used to find a set of best matching objects that are substantially similar to the specified object as described above.

### BRIEF DESCRIPTION OF THE DRAWINGS

Additional objects and features of the invention will be more readily apparent from the following detailed description and appended claims when taken in conjunction with the drawings, in which:

FIG. 1 illustrates a system that may be operated in accordance with an embodiment of the invention.

FIG. 2 illustrates two tables included in a database that may be used to implement an embodiment of the invention.

FIG. 3 illustrates the operation of a token generator in accordance with the preferred embodiment of the invention.

FIG. 4 illustrates the operation of a character module in accordance with the preferred embodiment of the invention.

FIG. 5 illustrates the operation of an assignment module in accordance with the preferred embodiment of the invention.

FIG. 6 illustrates the operation of a selection module in accordance with the preferred embodiment of the invention.

FIG. 7 illustrates the operation of a partition module in accordance with the preferred embodiment of the invention.

FIG. 8 shows processing steps executed to find a set of best matching names for a specified name in accordance with the preferred embodiment.

FIG. 9 illustrates the creation of a list of record identifiers from a table included in a database in accordance with an embodiment of the invention.

FIG. 10 illustrates the update of a count hash table preferably included in a database in accordance with an embodiment of the invention.

Like reference numerals refer to corresponding parts throughout the several views of the drawings.

### DESCRIPTION OF THE PREFERRED EMBODIMENTS

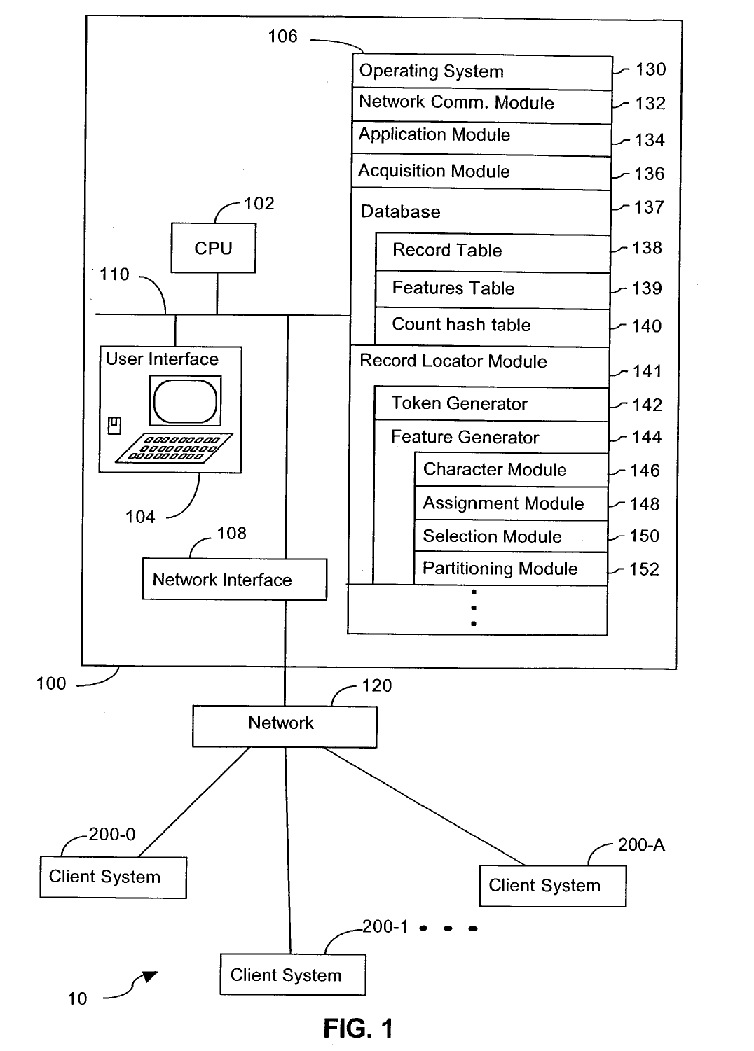

FIG. 1 illustrates a system 10 that may be operated in accordance with an embodiment of the invention. System 10 includes a plurality of client computers 200 and at least one server 100. Client computers 200 and server 100 are connected by a communications network 120. Network 120 is a local area network (LAN), wide area network (WAN), metropolitan area network (MAN), an intranet or the Internet, or a combination of such networks.

Server 100 includes standard server components such as a central processing unit 102, an optional user input/output device 104, a memory 106, a network interface 108 for coupling the server 100 to other computers via a communication network 120, and a bus 110 that interconnects these components. Memory 106, which typically includes high speed random access memory as well as non-volatile storage such as disk storage, stores an operating system 130 and a network communication module 132. Operating system 130 includes procedures for handling various basic system services and for performing hardware dependent tasks. Network communication module 132 is used for connecting to various client computers 200 and other servers 100 via network 120.

Memory 106 further stores an application module 134, an acquisition module 136, a database 137 and record locator module 141. Application module 134 is used to interfaces acquisition module 136, database 137, and record locator module 141. Acquisition module 136 processes new entries in the database 137 so as to generate feature values from each new entry for storage in the database 137. Database 137 is used for storing records, feature values and record identifiers (IDs). In particular, database 137 preferably comprises record table 138, features table 139, and, when needed, count hash table 140.

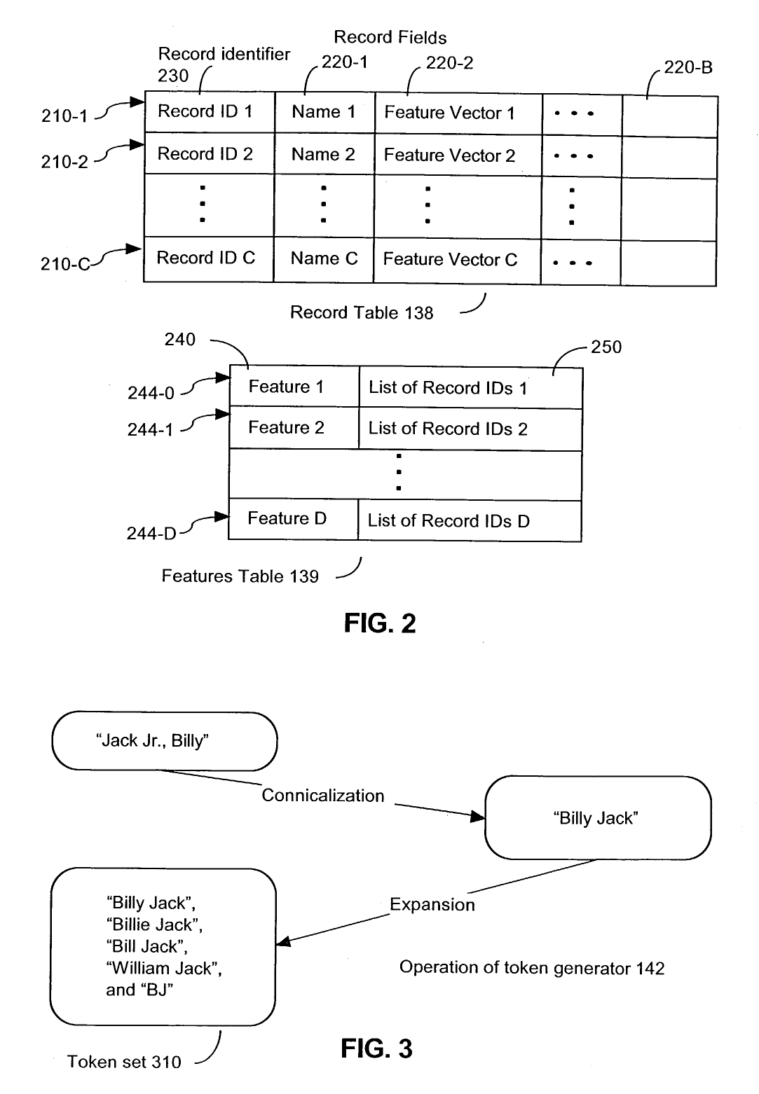

As illustrated in FIG. 2, record table 138 comprises a plurality of name records 210. Each name record 210 includes a plurality of record fields 220. In a preferred embodiment, field 220-1 stores a name associated with a given name record 210 and field 220-2 (or a group of fields) stores a feature vector generated for the name. Record table 138 also includes, in the preferred embodiment, a record ID field 230, which stores a record ID that uniquely identifies the name record 210. In an alternate embodiment, the record ID for each name record 210 is the index position of the name record 210 in the record table 138, which eliminates the need for a record ID field 230.

FIG. 2 also illustrates features table 139, which contains a list of the features for the names in the records table 138. The features table 139 contains a separate entry 244 for each distinct feature included in the feature vectors of all of the names stored in the record table 138 (i.e., each name record 210). Each entry 244 includes a feature value field 240 and a record ID list field 250. A record ID list identifies all the names with a feature vector that includes the feature value of a respective entry 244.

It is contemplated that a large number of names are processed to populate record table 138. This processing includes the steps needed to generate a feature vector for each of these names. These steps are described in detail with reference to FIGS. 3-7. And while names and feature vectors are stored in a record table 138, fast access to the feature vectors is provided by features table 139. As described in more detail below, features table 139 is to enable very efficient and rapid identification of all feature vectors (i.e., names) that share at least one feature with a feature vector of a specified name.

Furthermore, count hash table 140, which is shown in more detail in FIG. 10, is used to efficiently identify feature vectors that have at least a predefined number of features in common with the feature vector of the specified name.

Returning to FIG. 1, record locator module 141 is used to find a set of best matching names that are substantially identical to a specified name. When two names have a predetermined number of features in common, the likelihood that the two names are substantially identical is very high. The term “substantially identical” is herein defined to mean a very high degree of similarity, such as 90%, 98% or 99% similarity, depending on the implementation. The degree of similarity required is determined by the minimum number of features shared by a specified name and a name stored in the record table 138 (i.e., database 137). Thus, two names determined to be “substantially identical” may be 100% the same or minor variations of each other. Thus, names such as Bill Smith and William Smith may be determined to be “substantially identical.”

Similarly, the likelihood that a name closely resembles a name in the record table 138 is very high when a feature vector for the name shares a predetermined number of features with a feature vector of a name stored in the record table 138. A feature vector comprises a plurality of discrete features of a given name. In other words, a feature vector is a representation of a name. And in the preferred embodiment, each feature vector is a fixed size data structure. Further, each feature vector in the preferred embodiment includes fourteen features of eight bytes each. Of course, the number of features included in each feature vector and the size of each feature will vary from one implementation to another. The a feature vector is preferably sized, however, so that rapid comparisons of feature vectors are possible.

Methods for generating feature vectors for specified documents are disclosed in U.S. Pat. No. 6,119,124 entitled “Method For Clustering Closely Resembling Data Objects” and U.S. Pat. Nos. 5,909,677 and 6,230,155 both entitled “Method For Determining The Resemblance Of Documents”. Each of these patents is incorporated herein by reference as background information.

As indicated in FIG. 1, record locator module 141 includes token generator 142 and feature generator 144. Feature generator 144, furthermore, includes a character module 146, an assignment module 148, a selection module 150 and a partitioning module 152. The operation of these modules is explained below.

FIG. 3 illustrates the operation of the token generator 142, which generates a set of tokens for a specified name by applying a set of canonicalization rules and expansion rules to the name. A token is letter, word, number, or some combination thereof. Canonicalization rules include, for example, rules for removing noise characters, which do not help in the identification of a name (e.g., Inc., Jr., Sr., Dr., Corp., Ave., St.), rules for unifying character case, and rules for placing words followed by a comma at the end of the string (i.e., token). In contrast, expansion rules can expand a token (e.g., the specified name after being subjected to the canonicalization rules) to include phonetic variations, abbreviations, sequence variations, diminutives, and nicknames. For example, a token set 310 including “McDonald” may be expanded to also include “MacDonald”; a token set 310 including “Louis Paul” may be expanded to also include “Paul Louis”; a token set 310 including “Willy” may be expanded to also include “Bill”, “Billie”, “Billy”, “William” and/or “Willie”; and a token set 310 including “John F. Kennedy” may be expanded to also include “JFK”. Note, however, a resulting token or token set 310 may actually be shorter than the specified name if, for example, the canonicalization rules eliminate noise characters and the expansion rules are not applicable.

FIG. 3, in particular, illustrates the application of a set of canonicalization rules and expansion rules to the name “Jack Jr., Billy”. After applying the canonicalization rules listed above, the name becomes a token set 310 including “Billy Jack”. Note, the noise characters “Jr.” have been removed and the last name, which is identified by the comma, has been repositioned. And after applying the expansion rules listed above, the token set 310 “Billy Jack” is expanded to include: “Billy Jack”, “Billie Jack”, “Bill Jack”, “William Jack”, and “BJ”. The result may, however, vary depending on the precise set of rules used without departing from the scope of the invention. And as noted above, a token does not have to be an entire word. The illustrations discussed below, for example, reference tokens comprising a single letter.

Again, the feature generator 144 comprises a character module 146, an assignment module 148, a selection module 150, and a partitioning module 152. The feature generator 144 controls and augments the operation of these modules to generate a feature vector from a token set 310 provided by the token generator 142.

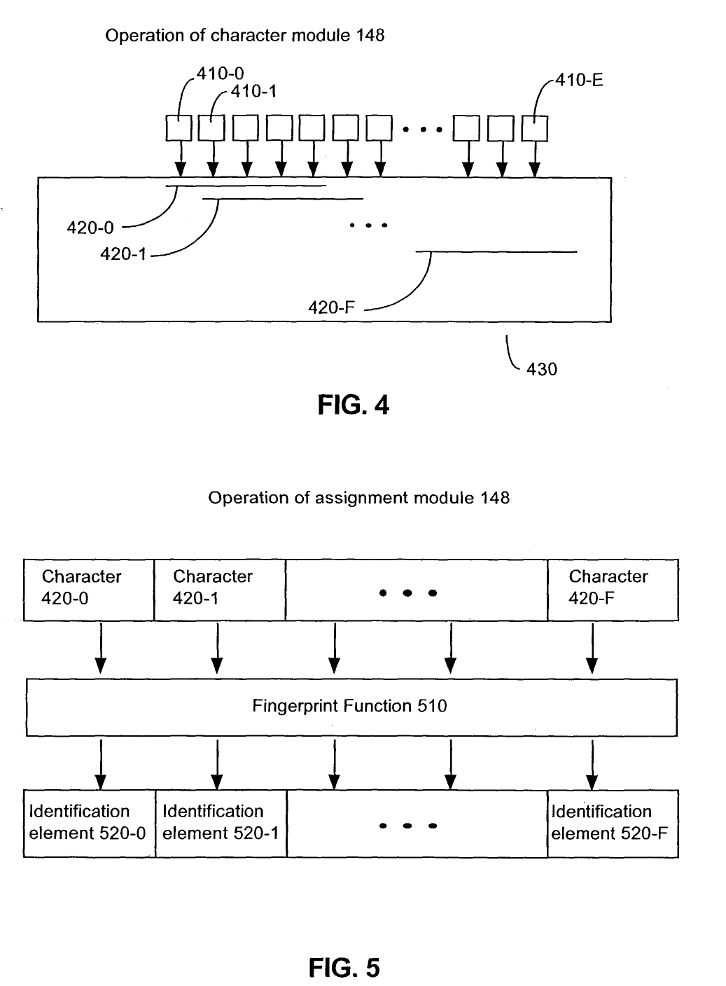

FIG. 4 illustrates the operation of the character module 146 in accordance with the preferred embodiment of the invention. The character module 146 generates characters 420, which together form a character set 430, by applying a shingling function to a token set 310 generated by the token generator 142. More specifically, the shingling function groups overlapping, fixed size sequences of contiguous tokens 410. For example, a set of 3-token characters 420 generated from the token 410 “Kennedy” can include the following characters: {Ken, enn, nne, ned, edy}. Similarly, a set of 2-token characters 420 generated from the token 410 “Kennedy” can include the following characters: {Ke, en, nn, ne, ed, dy}.

In some embodiments, the character set 430 may also include abbreviations or initials of names in addition to the extracted and repeated characters. In these and other embodiments, the character set 430 may include characters 420 comprising varying numbers of tokens 410. For example, the character set 430 may contain characters 420 comprising two tokens 410 and characters 420 comprising three tokens 410. In such embodiments, the token set 310 “John F. Kennedy” can produce the following character set 430: {J, JK, Jon, ohn, F, Ken, enn, nne, ned, edy, JFK}.

In still other embodiments, portions of a token set 310 that are determined by the character module 146 to be more important than others are repeated several times. In such embodiments, the token set 310 “John F. Kennedy” can produce the following character set 430: {J, J, J, JK, JK, Joh, ohn, F, Ken, Ken, enn, nne, ned, edy, JFK, JFK, JFK}.

FIG. 5 illustrates the operation of the assignment module 148, which assigns a generated identification element 520 (a.k.a. a fingerprint) to each character 420 of the character set 430 produced by the character module 146. Identification elements 520 are short tags for large or relatively large objects (i.e., characters 420). Importantly, when two identification elements 520 are different, the characters 420 from which the two identification elements 520 are generated are always different. Additionally, there is only an infinitesimally small probability that two distinct characters 420 have the same identification element 520 when subjected to the same fingerprint function 510.

As indicated above, an identification element 520 is preferably generated by subjecting the characters 420 of a character set 430 to a fingerprinting function 510. Preferably, the fingerprint function is based on Rabin fingerprints. A description of Rabin fingerprints is provided in M. O. Rabin, Fingerprinting by random polynomials, Center for Research in Computing Technology, Harvard University, Report TR-15-81, 1981, which is incorporated herein by reference. Additionally, in some embodiments, feature generator 144 assigns an identification element 520 only to unique characters 420 (and characters 420 the are replicated, important portions of a token 410 or token set 310), thus ignoring duplicate characters 420.

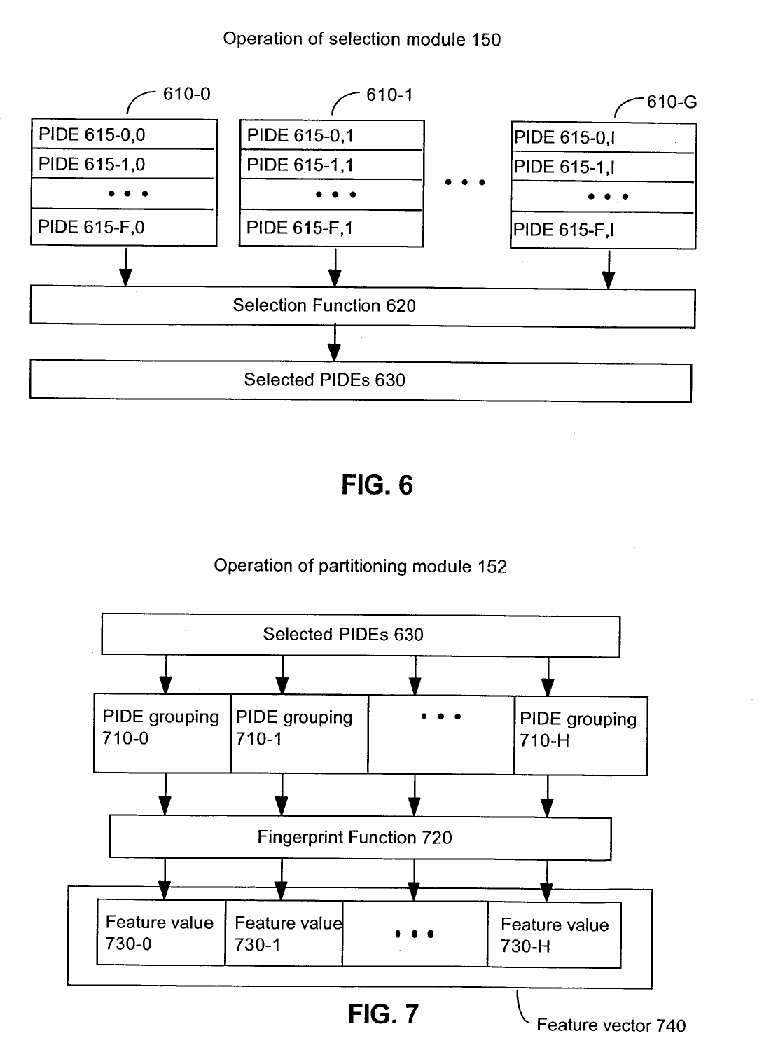

FIG. 6 illustrates the operation of a selection module 150 in accordance with an embodiment of the invention. The selection module 150 generates from the identification elements 520, permuted identification element (“PIDE”) sets 610 comprising a plurality of PIDEs 615. Each set of PIDEs 610 preferably includes one PIDE 615 for each identification element 520. For example, permuting identification element 520-0 according to a first permutation process produces PIDE 615-0,0 (i.e., a first permuted version of identification element 520-0). Each identification element 520 is subjected to the same permutation process to produce a given PIDE set 610. The permutation process used for each of the other PIDE sets 610 is, however, different. But once a particular permutation is selected to produce, for example, a first PIDE set 610, the same permutation is used for all subsequent first PIDE sets 610 (i.e., the first PIDE set 610 of a subsequent set of identification elements 520).

As a result, if a particular permutation or set of permutations is used while populating record table 138 with feature vectors corresponding to names stored in the record table 138, the same permutation or set of permutations must be used when searching the record table 138 for a set of best matching names for a specified name.

The selection module 150 then selects a predetermined number of PIDEs 615 (i.e., the selected PIDEs 630) from each PIDE set 610 using a selection function 620. In some embodiments, the selection function 620 selects the “smallest” PIDEs 615 from each set of PIDEs 610. In other embodiments, however, the “largest” PIDEs 615 (i.e., the PIDEs 615 having the largest numerical values) or the PIDEs 615 having the largest or smallest value when a particular function is applied to them are selected. In yet another embodiment, the selection function 620 selects a predefined number of the PIDEs 615 from all of the PIDE sets 610 without regard to which PIDE set 610 the selected PIDEs 615 originate. In this embodiment, therefore, the selection function 620 might not select any PIDEs 615 from one or more of the PIDE sets 620.

FIG. 7 illustrates the operation of the partitioning module 152, which together with other elements of the feature generator 144 generates feature values from the selected PIDEs 630. First, the partitioning module 152 creates a plurality of PIDE groupings 710 from the selected PIDEs 630. Preferably, each PIDE grouping 710 includes a plurality of the selected PIDEs 630. Furthermore, each group preferably includes the same number of the selected PIDEs 630 (e.g., six PIDEs 615 for each PIDE grouping 710).

Each PIDE grouping 710 is then reduced to a feature 730 through the application of a fingerprinting function 720. In a preferred embodiment, the fingerprinting function 720 is, or includes, a one way hash function that produces a fixed length feature value. A feature vector 740 for a given name comprises all of the feature values 730 generated by the fingerprinting function 720.

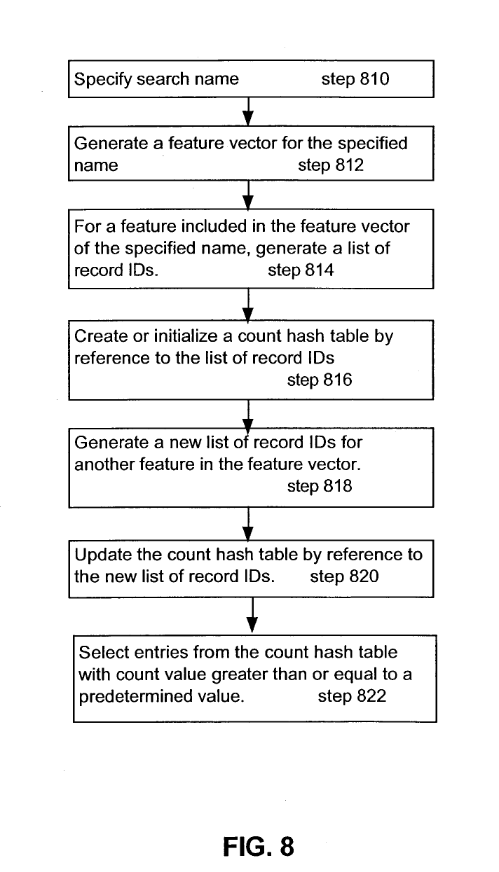

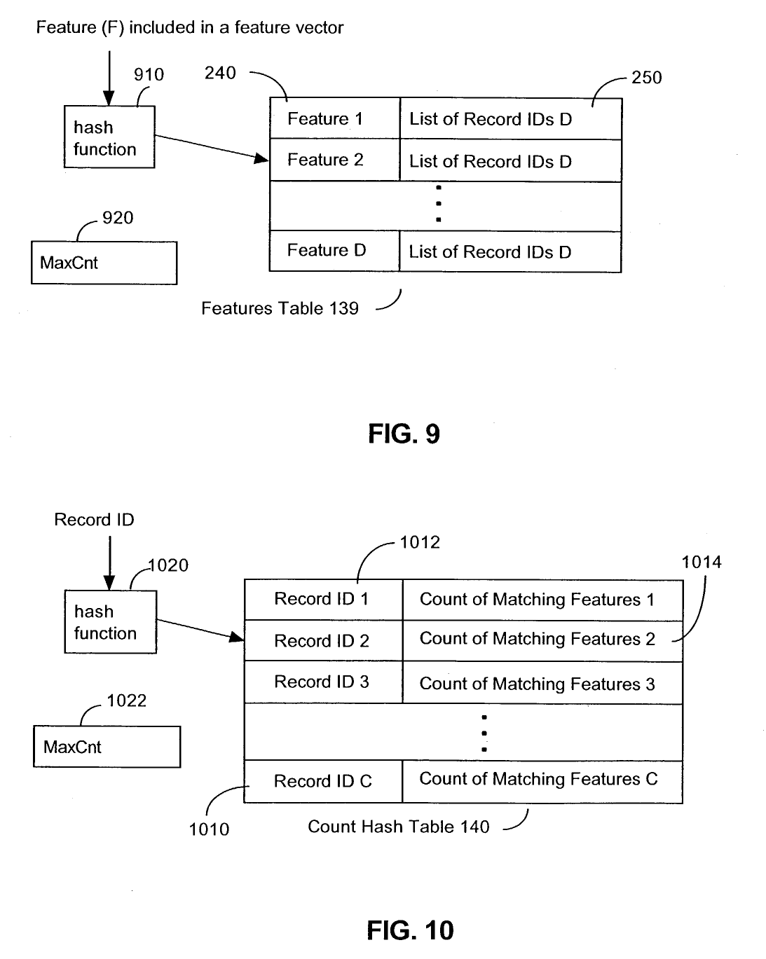

FIG. 8 shows the processing steps that are executed to find a set of best matching names for a specified name in accordance with the preferred embodiment. Briefly, the record locator module 141 generates a feature vector for the specified name and then finds names in the database 137 that share a predetermined number of features with the specified name.

In more detail now, a user specifies a search name (step 810). Record locator module 141 then generates a feature vector 740 for the specified name using token generator 142 and feature generator 144 as described in detail above (step 812).

After generating a feature vector 740 for the specified name, record locator module 141 finds names in the database 137 having a feature (e.g., a first feature) that is included in the feature vector 740 (step 814). More specifically, the record locator module 141 generates a record ID list wherein in each record ID corresponds to an entry 210 (i.e., a name) in the record table 138 having the feature included in the feature vector 740.

In a preferred embodiment, record locator module 141 finds the record ID list by performing a lookup in features table 139, which as noted above contains an entry 244 for each distinct feature of all of the names found in the record table 138. Included with each entry 244 is a feature value field 240 that stores a single, distinct feature and a field 250 that stores a record ID list, which identifies entries 210 in the record table 138 with the single, distinct feature.

To find the entry 244 for a specified feature F, a hash function 910 is applied to the value F of the specified feature to generate a pointer to an entry 244 in the features table 139. The features table 139 is then searched from that point (i.e., the entry 244 pointed to by the pointer) until either the record for the specified feature F is located or a maximum number (MaxCnt 920) of records 244 are searched, which indicates that the features table 139 does not contain an entry 244 for the specified feature F (i.e., none of the names stored in the record table 138 have feature F).

The MaxCnt 920 value is preferably updated each time a new entry 244 (i.e., a new feature) is added to the features table 139 and the displacement of the new entry 244 from the initial position identified by the hash function 910 (i.e., the entry 244 pointed to by the pointer) is greater than the previous MaxCnt 920 value.

Record locator module 141 then generates (or initializes) count hash table 140 (FIG. 10) with an entry 1010 for each record ID in the record ID list generated in step 814 (step 816). Each entry 1010 includes a first field 1012 for storing a record ID and a second field 1014 for storing a count value. The count value represents a count of matching features shared by the specified name and a name in database 137 identified by the corresponding record ID. Initially, each count relates only to a first feature, so it is initialized to the numerical value one.

Record locator module 141 then repeats step 814 for each feature included in the feature vector 740 (step 818). Each time step 814 is repeated (i.e., a new record ID list is created), the record locator module 141 updates the count hash table 140 created in step 816 by reference to the new record ID list (step 820). In particular, if a given record ID in a new record ID list is already in the count hash table 140, record locator module 141 increments the corresponding count value by the numerical value of one. But if the given record ID is not already in the count hash table 140, record locator module 141 creates an entry 1010 for the record ID as described above.

To search for an entry 1010 in the count hash table 140 corresponding to a given record ID, the record locator module 141 first generates a pointer to an entry 1010 by applying a hash function 1020 to the record ID. The record locator module 141 then searches the count hash table 140 from that point until either the entry 1010 for the record ID is located or a maximum number (MaxCnt 1022) of entries 1010 are searched, which indicates that the count hash table 140 does not contain an entry 1010 for the record ID.

The MaxCnt 1022 value is preferably updated each time a new entry 1010 (i.e., a new record ID) is added to the count hash table 140 and the displacement of the new entry from the initial position identified by the hash function 1020 (i.e., the entry 1010 pointed to by the pointer) is greater than the previous MaxCnt 1022 value.

After performing steps 814 through 822, record locator module 141 retrieves all entries 1010 in the count hash table 140 with a count equal to, greater than, or greater than or equal to a predetermined value (step 822). The names in the record table 138 corresponding to these entries comprise a set of best matching names for the name specified in step 810.

Record locator module 141 may then optionally display the entries 244 corresponding to these names on a computer display included in user interface 104 so that a user can verify whether one or more of these entries 244 corresponds to the name specified in step 810. The user can optionally perform an action in response to whether one or more of the retrieved records correspond to the specified record by for example modifying a record if one of the best matching records matches the specified record, by adding the specified name to the database if none of the best matching entries identifies the specified name, or by deleting entries if multiple entries of the same record exist. Thus, a user can find an entry in the database even if the entry is stored under a nickname or an abbreviation, cleanup an existing database where the database contains multiple entries of the same name with slight variations. In some embodiments, record locator module may locate all entries that are substantially similar to an entry in the database and automatically delete the located entries. In other embodiments, an operator is notified of the duplicate entries and can subsequently perform an action on the duplicate entries.

### Alternate Embodiments

Although the preceding description provides for locating similar names in a database, the invention may be used to locate any search term in any record field in a database or for locating multiple search terms in a record of a database. The present invention can be implemented as a computer program product that includes a computer program mechanism embedded in a computer readable storage medium. For instance, the computer program product could contain the program modules shown in FIG. 1. These program modules may be stored on a CD-ROM, magnetic disk storage product, or any other computer readable data or program storage product. The program modules may also be distributed electronically, via the Internet or otherwise, by transmission of a computer data signal (in which the program modules are embedded) on a carrier wave.

While the present invention has been described with reference to a few specific embodiments, the description is illustrative of the invention and is not to be construed as limiting the invention. Various modifications may occur to those skilled in the art without departing from the scope of the invention as defined by the appended claims.

What is claimed is:

1. A method for locating similar objects in a database, comprising the steps of:
applying a set of object expansion rules and a set of canonicalization rules to a specified object to generate a sequence of tokens;
applying a feature generation procedure to the sequence of tokens to generate a feature vector, the feature vector including a plurality of feature values, the feature generation procedure including:
generating a set of characters from the sequence of tokens;
assigning an identification element to each character in the set of characters to create a set of identification elements;
creating a set of permuted identification elements by subjecting each identification element in the set of identification elements to a permutation process;
selecting a predetermined number of permuted identification elements from the set of permuted identification elements to form a subset of permuted identification elements;
partitioning the subset of permuted identification elements into a plurality of groups;
producing a feature value from each of the plurality of groups to form the feature vector; and
finding a set of objects from among a plurality of objects in a database that have a predefined number of feature values in common with the feature vector, the database storing a plurality of feature values for each of the plurality of objects, said set of objects being similar to the specified object.

2. The method of claim 1, wherein
the set of canonicalization rules includes a rule to remove noise elements from the specified object.

3. The method of claim 1, wherein
the specified object comprises an address.

4. The method of claim 1, wherein
the specified object comprises a name.

5. The method of claim 4, wherein
each token in the sequence of tokens comprises a combination of elements drawn from a set of elements including letters and numbers.

6. The method of claim 4, wherein
the set of canonicalization rules includes a rule to set each letter of the object, if any, in the specified object to a predetermined case.

7. The method of claim 4, wherein
the set of canonicalization rules includes a rule to position a last name included in the specified object after a first name included in the specified object.

8. The method of claim 4, wherein
the set of expansion rules includes a rule to expand the specified object to include a common variation of the specified object.

9. The method of claim 4, wherein
the set of expansion rules includes a rule to expand the specified object to include an abbreviation of the specified object.

10. The method of claim 1, the generating includes
the use of a shingling function, said token sequence being subjected to said shingling function.

11. The method of claim 1, the generating further comprises
identifying one or more important tokens in the set of tokens; and
including in the set of characters two or more characters comprising the one or more important tokens.

12. The method of claim 11, wherein
the one or more important tokens are contiguous.

13. The method of claim 1, the assigning comprises
subjecting each character to a fingerprinting function to create the set of identification elements.

14. The method of claim 13, wherein
an identification element comprises a short tag for a corresponding character, said character being larger than the corresponding identification element.

15. The method of claim 13, wherein
whenever a first identification element is distinct from a second identification element, characters corresponding to the first identification element and the second identification element respectively are also distinct.

16. The method of claim 1, wherein
each permuted identification element in the set of permuted identification elements is a result of a common permutation process.

17. The method of claim 1, the creating further comprises
giving rise to a plurality of sets of permuted identification elements, wherein each of the plurality of sets of permuted identification elements is a product of a distinct permutation process.

18. The method of claim 17, the selecting comprises
picking a predefined number of permuted identification elements from each of the plurality of sets of permuted identification elements to form the subset of permuted identification elements.

19. The method of claim 1, wherein
each of the plurality of groups includes an identical number of permuted identification elements.

20. The method of claim 1, the producing comprises
reducing each group from the plurality of groups through the application of a function that produces a corresponding feature value, said feature value being smaller than a respective group.

21. The method of claim 1, the producing includes
the application of a hash function to the each of the plurality of groups.

22. The method of claim 1, wherein the finding includes:
extracting from the database a set of object identifiers, each object identifier from the set of object identifiers identifying an object having a first feature value included in the feature vector;
creating a count hash table by reference to the set of object identifiers, each entry in the count hash table corresponding to an object identifier from the set of object identifiers, each entry including a count set to a numerical value of one to indicate that a respective object has the first feature value in common with the feature vector;
repeating said extracting step for each additional feature value in the feature vector, if any, to produce an additional set of object identifiers for each additional feature value in the feature vector; and
updating the count hash table by reference to the additional set of object identifiers, said updating including
incrementing the count of each existing entry in the count hash table that corresponds to an object identifier included in the additional set of object identifiers;
adding a new entry to the count hash table for each object identifier included in the additional set of object identifiers that does not correspond to an existing entry in the count hash table, the count of the new entry being set to the numerical value of one; and
searching the count hash table for entries having a count indicating that a corresponding object has the predefined number of feature values in common with the plurality of feature values.

23. The method of claim 1, wherein the feature vector is a fixed size data structure, said fixed size being independent of the specified object.

24. The method of claim 1, further including
creating an entry in the database for the specified object.

25. The method of claim 24, the creating includes
assigning an object identifier to the specified object;
generating a feature vector for the specified object using said applying steps, said entry including the object identifier and the feature vector.

26. The method of claim 24, wherein
the database comprises an entry for each feature in a list of features, each entry including a feature and a set of object identifiers identifying an object with the feature;
the creating includes:
assigning an object identifier to the specified object;
generating a feature vector for the specified object using said applying steps;
adding the object identifier to the set of object identifiers included in an existing entry that corresponds to a feature included in the feature vector for the specified object; and
creating an entry in the database for each feature in the feature vector for the specified object not already included in the list of features.

27. A computer program product for use in conjunction with a computer system, the computer program product comprising a computer readable medium and a computer program mechanism embedded therein, the computer program mechanism comprising:
a database for storing a plurality of objects and feature vectors corresponding to each of said plurality of objects; and
a record locator module including
instructions for applying a set of object expansion rules and a set of canonicalization rules to a specified object to generate a sequence of tokens;
instructions for generating a set of characters from the sequence of tokens;
instructions for assigning an identification element to each character in the set of characters to create a set of identification elements;
instructions for creating a set of permuted identification elements by subjecting each identification element in the set of identification elements to a permutation process;
instructions for selecting a predetermined number of permuted identification elements from the set of permuted identification elements to form a subset of permuted identification elements;
instructions for partitioning the subset of permuted identification elements into a plurality of groups;
instructions for producing a feature value from each of the plurality of groups to form a plurality of feature values; and
instructions for finding a set of objects from among a plurality of objects in a database that have a predefined number of feature values in common with the plurality of feature values, said set of objects being similar to the specified object.

28. The computer program product of claim 27, wherein
the set of canonicalization rules includes a rule to remove noise elements from the specified object.

29. The computer program product of claim 27, wherein
the specified object comprises an address.

30. The computer program product of claim 27, wherein
the specified object comprises a name.

31. The computer program product of claim 30, wherein
each token in the sequence of tokens comprises a combination of elements drawn from a set of elements including letters and numbers.

32. The computer program product of claim 30, wherein
the set of canonicalization rules includes a rule to set each letter of the object, if any, in the specified object to a predetermined case.

33. The computer program product of claim 30, wherein
the set of canonicalization rules includes a rule to position a last name included in the specified object after a first name included in the specified object.

34. The computer program product of claim 30, wherein
the set of expansion rules includes a rule to expand the specified object to include a common variation of the specified object.

35. The computer program product of claim 30, wherein
the set of expansion rules includes a rule to expand the specified object to include an abbreviation of the specified object.

36. The computer program product of claim 27, the instructions for generating the set of characters from the sequence of tokens include
instructions for applying a shingling function to each of the set of tokens.

37. The computer program product of claim 27, the instructions for generating the set of characters from the sequence of tokens further comprise
instructions for identifying one or more important tokens in the set of tokens; and
instructions for including in the set of characters two or more characters comprising the one or more important tokens.

38. The computer program product of claim 37, wherein
the one or more important tokens are contiguous.

39. The computer program product of claim 27, the instructions for assigning the identification element to each character in the set of characters to create the set of identification elements comprise
instructions for subjecting each character to a fingerprinting function to create the set of identification elements.

40. The computer program product of claim 39, wherein
an identification element comprises a short tag for a corresponding character, said character being larger than the corresponding identification element.

41. The computer program product of claim 39, wherein
whenever a first identification element is distinct from a second identification element, characters corresponding to the first identification element and the second identification element respectively are also distinct.

42. The computer program product of claim 27, wherein
each permuted identification element in the set of permuted identification elements is a result of a common permutation process.

43. The computer program product of claim 27, the instructions for creating the set of permuted identification elements by subjecting each identification element in the set of identification elements to the permutation process further comprise
instructions for giving rise to a plurality of sets of permuted identification elements, wherein each of the plurality of sets of permuted identification elements is a product of a distinct permutation process.

44. The computer program product of claim 43, the instructions for selecting the predetermined number of permuted identification elements from the set of permuted identification elements to form the subset of permuted identification elements comprise
instructions for picking a predefined number of permuted identification elements from each of the plurality of sets of permuted identification elements to form the subset of permuted identification elements.

45. The computer program product of claim 27, wherein
each of the plurality of groups includes an identical number of permuted identification elements.

46. The computer program product of claim 27, the instructions for producing the feature value from each of the plurality of groups to form the plurality of feature values comprise
instructions for reducing each group from the plurality of groups through the application of a function that produces a corresponding feature value, said feature value being smaller than a respective group.

47. The computer program product of claim 27, the instructions for producing the feature value from each of the plurality of groups to form the plurality of feature values include
instructions for the application of a hash function to the each of the plurality of groups.

48. The computer program product of claim 27, wherein the instructions for finding the set of objects from among the plurality of objects in the database that have the predefined number of feature values in common with the plurality of feature values include:
instructions for extracting from the database a set of object identifiers, each object identifier from the set of object identifiers identifying an object having a first feature value included in the plurality of feature values;
instructions for creating a count hash table by reference to the set of object identifiers, each entry in the count hash table corresponding to an object identifier from the set of object identifiers, each entry including a count set to a numerical value of one to indicate that a respective object has the first feature value in common with the plurality of feature values;
instructions for repeating said extracting step for each additional feature value in the plurality of feature values, if any, to produce an additional set of object identifiers for each additional feature value in the plurality of feature values; and
instructions for updating the count hash table by reference to the additional set of object identifiers, said instruction for updating including
instructions for incrementing the count of each existing entry in the count hash table that corresponds to an object identifier included in the additional set of object identifiers;
instructions for adding a new entry to the count hash table for each object identifier included in the additional set of object identifiers that does not correspond to an existing entry in the count hash table, the count of the new entry being set to the numerical value of one; and
instructions for searching the count hash table for entries having a count indicating that a corresponding object has the predefined number of feature values in common with the plurality of feature values.

49. The computer program product of claim 27, wherein the plurality of feature values is a fixed size data structure, said fixed size being independent of the specified object.

50. The computer program product of claim 27, further including
instructions for creating an entry in the database for the specified object.

51. The computer program product of claim 50, the instructions for creating the entry in the database for the specified object include
instructions for assigning an object identifier to the specified object;
instructions for generating a feature vector for the specified object using said applying steps, said entry including the object identifier and the feature vector.

52. The computer program product of claim 50, wherein
the database comprises an entry for each feature in a list of features, each entry includes a feature and a set of object identifiers identifying an object with the feature;
the instructions for creating the entry in the database for the specified object include:
instructions for assigning an object identifier to the specified object;
instructions for generating a feature vector for the specified object using said applying steps;
instructions for adding the object identifier to the set of object identifiers included in an existing entry that corresponds to a feature included in the plurality of feature values; and
instructions for creating an entry in the database for each feature in the plurality of feature values not already included in the list of features.

53. A computer system for locating similar names in a database, the computer system comprising
a central processing unit; and
a memory, coupled to the central processing unit, the memory storing
a database for storing a plurality of objects and feature vectors corresponding to each of said plurality of objects; and
a record locator module including
instructions for applying a set of object expansion rules and a set of canonicalization rules to a specified object to generate a sequence of tokens;
instructions for applying a feature generation procedure to the sequence of tokens to generate a feature vector, the feature vector including a plurality of features, the feature generation procedure including instructions for:
generating a set of characters from the sequence of tokens;
assigning an identification element to each character in the set of characters to create a set of identification elements;
creating a set of permuted identification elements by subjecting each identification element in the set of identification elements to a permutation process;
selecting a predetermined number of permuted identification elements from the set of permuted identification elements to form a subset of permuted identification elements;
partitioning the subset of permuted identification elements into a plurality of groups;
producing a feature value from each of the plurality of groups to form the plurality of feature values; and
instructions for finding a set of objects from among a plurality of objects in a database that have a predefined number of feature values in common with the plurality of feature values, said set of objects being similar to the specified object.

54. The computer system of claim 53, wherein
the set of canonicalization rules includes a rule to remove noise elements from the specified object.

55. The computer system of claim 53, wherein
the specified object comprises an address.

56. The computer system of claim 53, wherein
the specified object comprises a name.

57. The computer system of claim 56, wherein
each token in the sequence of tokens comprises a combination of elements drawn from a set of elements including letters and numbers.

58. The computer system of claim 56, wherein
the set of canonicalization rules includes a rule to set each letter of the object, if any, in the specified object to a predetermined case.

59. The computer system of claim 56, wherein
the set of canonicalization rules includes a rule to position a last name included in the specified object after a first name included in the specified object.

60. The computer system of claim 56, wherein
the set of expansion rules includes a rule to expand the specified object to include a common variation of the specified object.

61. The computer system of claim 56, wherein
the set of expansion rules includes a rule to expand the specified object to include an abbreviation of the specified object.

62. The computer system of claim 53, the instructions for generating the set of characters from the sequence of tokens include
instructions for applying a shingling function to each of the set of tokens.

63. The computer system of claim 53, the instructions for generating the set of characters from the sequence of tokens further comprise
instructions for identifying one or more important tokens in the set of tokens; and
instructions for including in the set of characters two or more characters comprising the one or more important tokens.

64. The computer system of claim 63, wherein
the one or more important tokens are contiguous.

65. The computer system of claim 53, the instructions for assigning the identification element to each character in the set of characters to create the set of identification elements comprise
instructions for subjecting each character to a fingerprinting function to create the set of identification elements.

66. The computer system of claim 65, wherein
an identification element comprises a short tag for a corresponding character, said character being is larger than the corresponding identification element.

67. The computer system of claim 65, wherein
whenever a first identification element is distinct from a second identification element, characters corresponding to the first identification element and the second identification element respectively are also distinct.

68. The computer system of claim 53, wherein
each permuted identification element in the set of permuted identification elements is a result of a common permutation process.

69. The computer system of claim 53, the instructions for creating the set of permuted identification elements by subjecting each identification element in the set of identification elements to the permutation process further comprise
instructions for giving rise to a plurality of sets of permuted identification elements, wherein each of the plurality of sets of permuted identification elements is a product of a distinct permutation process.

70. The computer system of claim 69, the instructions for selecting the predetermined number of permuted identification elements from the set of permuted identification elements to form the subset of permuted identification elements comprise
instructions for picking a predefined number of permuted identification elements from each of the plurality of sets of permuted identification elements to form the subset of permuted identification elements.

71. The computer system of claim 53, wherein
each of the plurality of groups includes an identical number of permuted identification elements.

72. The computer system of claim 53, the instructions for producing the feature value from each of the plurality of groups to form the plurality of feature values comprise
instructions for reducing each group from the plurality of groups through the application of a function that produces a corresponding feature value, said feature value being smaller than a respective group.

73. The computer system of claim 53, the instructions for producing the feature value from each of the plurality of groups to form the plurality of feature values include
instructions for the application of a hash function to the each of the plurality of groups.

74. The computer system of claim 53, wherein the instructions for finding the set of objects from among the plurality of objects in the database that have the predefined number of feature values in common with the plurality of feature values include:
instructions for extracting from the database a set of object identifiers, each object identifier from the set of object identifiers identifying an object having a first feature value included in the feature vector;
instructions for creating a count hash table by reference to the set of object identifiers, each entry in the count hash table corresponding to an object identifier from the set of object identifiers, each entry including a count set to a numerical value of one to indicate that a respective object has the first feature value in common with the feature vector;
instructions for repeating said extracting step for each additional feature value in the feature vector, if any, to produce an additional set of object identifiers for each additional feature value in the feature vector; and
instructions for updating the count hash table by reference to the additional set of object identifiers, said instruction for updating including
instructions for incrementing the count of each existing entry in the count hash table that corresponds to an object identifier included in the additional set of object identifiers;
instructions for adding a new entry to the count hash table for each object identifier included in the additional set of object identifiers that does not correspond to an existing entry in the count hash table, the count of the new entry being set to the numerical value of one; and
instructions for searching the count hash table for entries having a count indicating that a corresponding object has the predefined number of feature values in common with the plurality of feature values.

75. The computer system of claim 53, wherein the feature vector is a fixed size data structure, said fixed size being independent of the specified object.

76. The computer system of claim 53, further including
instructions for creating an entry in the database for the specified object.

77. The computer system of claim 76, the instructions for creating the entry in the database for the specified object include
instructions for assigning an object identifier to the specified object;
instructions for generating a feature vector for the specified object using said applying steps, said entry including the object identifier and the feature vector.

78. The computer system of claim 76, wherein
the database comprises an entry for each feature in a list of features, each entry includes a feature and a set of object identifiers identifying an object with the feature;
the instructions for creating the entry in the database for the specified object include:
instructions for assigning an object identifier to the specified object;
instructions for generating a feature vector for the specified object using said applying steps;
instructions for adding the object identifier to the set of object identifiers included in an existing entry that corresponds to a feature included in the feature vector for the specified object; and
instructions for creating an entry in the database for each feature in the feature vector for the specified object not already included in the list of features.
